(19) United States
(12) Patent Application Publication
(10) Pub. No.: US 2011/0142435 A1
(43) Pub. Date: Jun. 16, 2011

(54) APPARATUS AND METHOD FOR ESTIMATING REFLECTANCE AND DIFFUSE ELEMENTS FOR REALISTIC HUMAN MODEL RENDERING

(75) Inventors: Jeung Chul PARK, Daejeon (KR); Bon Ki KOO, Daejeon (KR)

(73) Assignee: Electronics and Telecommunications Research Institute, Daejeon (KR)

(21) Appl. No.: 12/794,319

(22) Filed: Jun. 4, 2010

(30) Foreign Application Priority Data
Dec. 11, 2009 (KR) 10-2009-0123460

(51) Int. Cl. G03B 15/03

(52) U.S. Cl. 396/155

(57) ABSTRACT

Provided are an apparatus and method for estimating reflectance and diffuse elements as optical properties of skin to perform exact rendering on human skin. The apparatus includes a light source device equipping a plurality of light sources that control directions toward an object, a control unit controlling sequential switching of the light sources, and a photographing unit photographing images of the object. The photographing unit is a DSLR camera providing a video photographing function. The entire light sources are controlled to be sequentially switched for a second correspondingly to the number of frames of the photographing unit per second. The control unit and the photographing unit are controlled by a computer. The computer repeats operations of requesting to the control unit to perform a lighting operation, transmitting an image acquisition command to the photographing unit, and requesting the control unit to perform a lighting operation again.

### CROSS-REFERENCE TO RELATED APPLICATIONS

This application claims priority under 35 U.S.C. §119 to Korean Patent Application No. 10-2009-0123460, filed on Dec. 11, 2009, in the Korean Intellectual Property Office, the disclosure of which is incorporated herein by reference in its entirety.

### TECHNICAL FIELD

The following disclosure relates to a technology on rendering as a portion of computer graphics, and in particular, to an apparatus and method for estimating optical properties for performing realistic skin model rendering.

### BACKGROUND

Much research has been made for rendering a human skin quality in computer graphic. However, since the human skin quality having a multilayer structure of a translucent quality differently from the quality of general objects such as silver, wood and metal has reflection and diffusion properties, it is difficult to estimate the human skin quality. In case of wood and metal models, unique properties of the models are estimated by using light sources in diverse situations by extending an estimation time. However, it is nearly impossible to estimate the human skin without motion continuously for a long time while varying the locations of the light sources.

Accordingly, simple estimation of the human skin quality is preferred in the related arts to equipping of a system for estimating the exact human skin quality or exact estimation of all parts of the human skin. A research by Paul Devebec is one of the related arts. His invention relates to preparing a structure of icosahedron, estimating reflectance generated in a light source of 150 directions as a super-high speed camera, and performing rendering on a face.

More noises are generated in an image acquired in the super-high speed camera than an image acquired in a Digital Single-Lens Reflex (DSLR) camera of low resolution. Also, since the super-high speed camera does not exactly synchronize a lighting time of illumination, there is a limitation that only a part of the acquired images can be used.

### SUMMARY

In one general aspect, an apparatus for estimating optical properties, includes: a light source device equipping a plurality of light sources that control directions toward an object; a control unit controlling sequential switching of the light sources; and a photographing unit photographing images of the object.

The light source device may have a shape similar to a sphere and the photographing unit preferably may be a Digital Single-Lens Reflex (DSLR) camera providing a video photographing function. The entire light sources are controlled to be sequentially switched for a second correspondingly to the number of frames of the photographing unit per second.

The apparatus may further include a computer controlling the control unit and the photographing unit.

The computer may repeat operations of requesting the control unit to perform a lighting operation, transmitting an image acquisition command to the photographing unit when the control unit sends a reply that the light source is turned on after lighting of one light source among a plurality of light sources, and requesting lighting to the control unit again when the photographing unit sends a reply that images are acquired after image acquisition.

The apparatus may further include a support supporting the object in order to prevent a motion of the object. The light source may be a Light-Emitting Diode (LED) light source.

The apparatus may further include a projector projecting an object to estimate diffuse elements under a surface of the object.

In another general aspect, a method for estimating optical properties by using the apparatus for estimating optical properties, includes: requesting a control unit to perform a lighting operation; turning on, by the control unit, one light source among a plurality of light sources; receiving a reply that the light source is turned on from the control unit; transmitting an image acquisition command to a photographing unit; acquiring, by the photographing unit, images; and receiving a reply that the images are acquired from the photographing unit.

Other features and aspects will be apparent from the following detailed description, the drawings, and the claims.

### BRIEF DESCRIPTION OF THE DRAWINGS

FIG. 1 is a diagram showing a light source device according to an exemplary embodiment.

FIG. 2 is a diagram showing an angle controller used in the light source device according to an exemplary embodiment.

FIG. 3 is a diagram showing a jaw support used in an apparatus for estimating optical properties according to an exemplary embodiment.

FIG. 4 is a diagram showing a method for synchronizing illumination in the apparatus for estimating optical properties according to an exemplary embodiment.

FIG. 5 is a diagram showing an entire structure of the apparatus for estimating optical properties and a method for estimating reflectance according to an exemplary embodiment.

FIG. 6 is a flowchart describing a method for estimating diffuse elements according to an exemplary embodiment.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings. Reflectance and diffuse elements of human skin are estimated and used in rendering of a realistic skin model according to an exemplary embodiment.

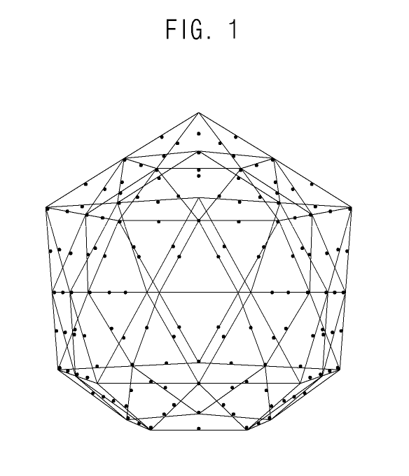

A method for estimating reflectance of the human skin will be described in detail. FIG. 1 shows a structure for estimating reflectance according to an exemplary embodiment.

As shown in FIG. 1, the structure for estimating reflectance according to an exemplary embodiment has a form of regular icosahedron.

Ideally for exact estimation, estimation should be performed in all directions of light sources by using a sphere, but it is physically impossible because the estimation of massive data is required in this case. Accordingly, a regular icosahedron is adopted in an exemplary embodiment. Although the regular icosahedron is basically used, a structure that small triangles are included inside each triangle is also adopted. Thus, the structure of the regular icosahedron is used in the exemplary embodiment, but it is apparent that structures of other forms may be used when the structures have a form similar to a sphere.

In this structure, each vertex and a center of a segment (edge) connecting the vertexes are positions where the light sources are located. The light sources are acquired in total directions of 156. However, since a space for a model is required, 5 small triangles inside a large triangle of icosahedrons are removed. When the 5 small triangles are removed, light sources of 150 directions in total are acquired.

Since the shape of the structure is close to a sphere but not a complete sphere, directions of the light sources located in the vertexes and particularly the center of the segment are not toward the exact center. Accordingly, an angle controller for controlling the direction of the light sources toward the center is installed.

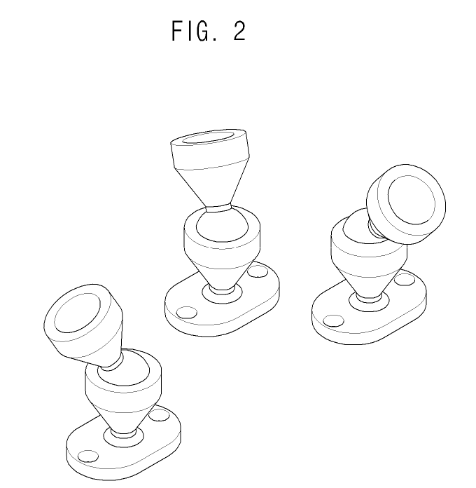

FIG. 2 shows angle controllers installed on the structure to control the angle of the light source according to an exemplary embodiment.

The structure for estimating reflectance according to an exemplary embodiment uses a Light-Emitting Diode (LED) light source, which will be called LED hereinafter, as a light source. LED is superior in acquiring high quality data since a switch time is short and values of luminance and color temperature are high. In LED used in the exemplary embodiment, a luminance value is 430 lux and a color temperature value is 6500K.

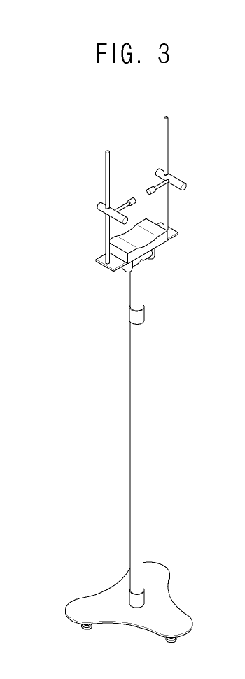

Finally, a model should stay still when reflectance is estimated. It is required to grasp properties of light sources in all directions to find optical properties of skin in a specific part. A motion makes it difficult to determine whether the optical properties are acquired from an estimated part since the estimated part is mixed with other parts by the motion. However, people don't stand still for a few second or minute without any device. Accordingly, a device for maintaining the minimum motion until the estimation finishes is necessary. FIG. 3 shows a jaw support for fixing a human face according to an exemplary embodiment.

The jaw support shown in FIG. 3 is located inside the structure shown in FIG. 1 and estimates reflectance by putting the human face on the jaw support and fixing the human face.

A light source control system installed in the structure as described above will be described hereafter. It is most important in the control system to acquire data within a short time. The light sources of 150 directions are installed in the structure and optimal data should be acquired for lighting within the shortest time from a light source located at the top to a light source located at the bottom. Accordingly, synchronization of illumination is required. The synchronization of illumination means that each illumination is switched within a predetermined time.

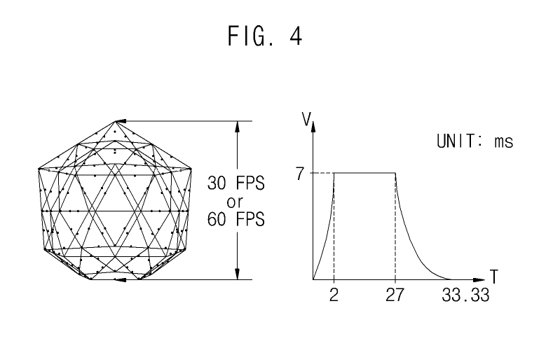

FIG. 4 is a diagram showing a method for controlling illumination to be synchronized according to an exemplary embodiment. As shown in a graph of FIG. 4, a switching time of one illumination is calculated as 33.33 ms and it is on the basis of 30 fps that can be acquired in the camera. As the illumination control method, when a controller generates a 30 Hz wave, the controller issues a command for turning on the light at a time that the wave falls. That is, like the graph of FIG. 4, the light is automatically turned off after 27 ms from the issuance of the lighting command. It is because it takes longer than 6 ms until the light is completely turned off. The light should be turned off before 27 ms from the lighting. If it doesn't, two illuminations are simultaneously turned on.

When the illumination synchronization is completed and the illumination is turned on as 30 frames per second, the illumination should be synchronized with the camera. The synchronization with the camera means acquiring images within 2˜27 ms as the lighting time of the illumination. Thus, a shutter of the camera is controlled by generally using a synch-generator for synchronization. However, the synchronization according to the above method requires using a camera for broadcasting and a general CCD camera. In addition, the camera for broadcasting uses an expensive broadcasting device of a price higher than tens of thousands of dollars and has a bad resolution. Since the resolution is an important factor in estimating reflectance of the optical properties, a method for overcoming the limitations in the synchronization and the resolution is essentially required.

In the exemplary embodiment, a Digital Single-Lens Reflex (DSLR) camera that provides a video mode is used. Since the DSLR camera cannot use the synch-generator, only black images may be acquired in a bad case while 150 images are taken. In a test result, one or two images of acquired 100 images are black and it means that a possibility of acquiring the black images is very low. Accordingly, final data are acquired by the DSLR camera. It takes a short time of 5 seconds to acquire 150 images.

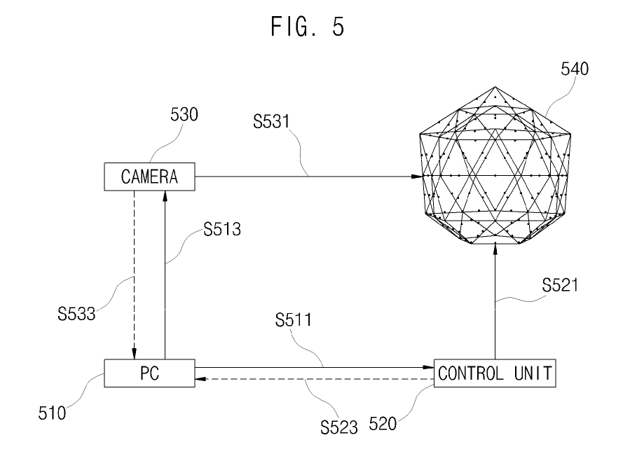

Another test is taken to acquire a resolution of higher than 1080p. In this test, a computer is used to control a camera and illumination. FIG. 5 shows a system configuration for the test according to an exemplary embodiment.

As shown in FIG. 5, in operation S511, a computer 510 requests lighting to a control unit 520 controlling an illumination apparatus 540. The control unit 520 turns on a first illumination of the illumination apparatus 540 in operation S521 and sends a reply that the first illumination is turned on to the computer in operation S523. In operation S513, the computer 510 commands a camera 530 to acquire an image. The camera 530 acquires the image in operation S531 and sends a signal that the image is completely acquired to the computer 510 again in operation S533. When the above operations are repeated, entire images are acquired.

A typical DSLR camera acquires only a still image of a high resolution, but many recently released DSLR cameras have a function of a high resolution video.

Accordingly, the DSLR camera is used in the exemplary embodiment to estimate a reflectance value of a high quality and the reflectance can be exactly estimated by using a high-quality image by synchronizing the illumination and the camera.

A method for estimating diffuse elements to exactly perform rendering on a skin model will be described. Rendering on the skin model should be performed based on both of the reflectance as a feature on the surface and the diffuse elements as a feature under the surface. A projector is used to estimate the diffuse elements.

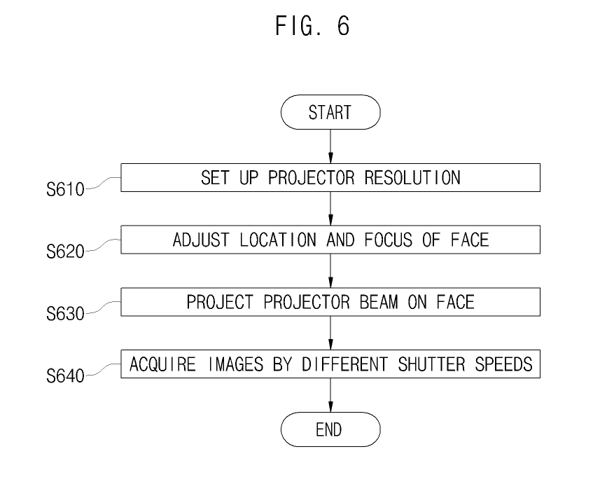

FIG. 6 is a flowchart describing a method for estimating diffuse elements according to an exemplary embodiment.

In operation S610, a resolution of the projector is set up. Since the general projector shows optimal performance in a resolution of 1024×768, the projector adopts the resolution. In operation S620, a location and a focus are adjusted such that a incidence plane of the projector is occupied with a face.

In operation S630, a projector beam is projected on the face. It is for estimating diffuse elements on each region by projecting 6 regions of a forehead, a nose, lips, a chin, a cheekbone and cheek.

Images of many stages are acquired by different shutter speeds in the set up projector in operation S640. Accordingly, a small circular pixel is acquired in six portions of the image and the diffuse elements are acquired after generating a High Dynamic Range (HDR) image based on the acquired data.

A number of exemplary embodiments have been described above. Nevertheless, it will be understood that the apparatus and method for estimating reflectance and diffuse elements are not limited to the exemplary embodiments and various changes and modifications may be made without deviating from the basic concept and range. Accordingly, if the changes and modifications fall under the scope of the basic idea, they are within the scope of the following claims.

What is claimed is:

1. An apparatus for estimating optical properties, comprising:
a light source device comprising a plurality of light sources that control directions toward an object;
a control unit controlling sequential switching of the light sources; and
a photographing unit photographing images of the object.

2. The apparatus of claim 1, wherein the light source device has a shape similar to a sphere.

3. The apparatus of claim 1, wherein the photographing unit is a Digital Single-Lens Reflex (DSLR) camera providing a video photographing function.

4. The apparatus of claim 1, wherein the entire light sources are controlled to be sequentially switched for a second correspondingly to the number of frames of the photographing unit per second.

5. The apparatus of claim 1, further comprising a computer controlling the control unit and the photographing unit.

6. The apparatus of claim 5, wherein the computer repeats operations of requesting a control unit to perform a lighting operation, transmitting an image acquisition command to the photographing unit when the control unit sends a reply that the light source is turned on after lighting of one light source among a plurality of light sources, and requesting the control unit to perform the lighting operation again when the photographing unit sends a reply that images are acquired after image acquisition.

7. The apparatus of claim 1, further comprising a support supporting the object in order to prevent a motion of the object.

8. The apparatus of claim 1, wherein the light source is a Light-Emitting Diode (LED) light source.

9. The apparatus of claim 1, further comprising a projector projecting an object to estimate diffuse elements under a surface of the object.

10. A method for estimating optical properties by using the apparatus defined in claim 1, the method comprising the steps of:
requesting a control unit to perform a lighting operation;
turning on, by the control unit, one light source among a plurality of light sources;
receiving a reply that the light source is turned on from the control unit;
transmitting an image acquisition command to a photographing unit;
acquiring, by the photographing unit, images; and
receiving a reply that the images are acquired from the photographing unit.

11. The method of claim 10, wherein the requesting of a control unit and the receiving of a reply that the images are acquired are repeated on the entire light sources.

12. The method of claim 10, wherein the photographing unit is a Digital Single-Lens Reflex (DSLR) camera providing a video photographing function.

13. The method of claim 10, wherein the entire light sources are controlled to be sequentially switched for a second correspondingly to the number of frames of the photographing unit per second.
